(19) United States
(12) Patent Application Publication
(10) Pub. No.: US 2010/0319475 A1
(43) Pub. Date: Dec. 23, 2010

(54) HELICAL BEVEL GEAR HAVING AXIAL ELASTIC SHAFT MOUNTING AND ELECTRICAL AUXILIARY CONTROL EQUIPPED THEREWITH

(76) Inventor: Dennis Füchsel, Schwabisch Gmund (DE)

Correspondence Address: Horst M Kasper, 13 Forest Drive, Warren, NJ, 07059, US

(21) Appl. No.: 12/736,014

(22) PCT Filed: Mar. 3, 2009
(86) PCT No.: PCT/EP2009/001493

§ 371 Date: Aug. 31, 2010

(30) Foreign Application Priority Data
Mar. 4, 2008 (DE) 10 2008 000 506.1

(51) Int. Cl. F16H 35/00

(52) U.S. Cl. 74/388 PS

(57) ABSTRACT

A helical bevel gear is proposed, in particular a worm gear, for an electrical auxiliary control, wherein said gear (G) has a pinion or a worm (1), which can be connected to a drive shaft of an electrical drive motor, and which is disposed in a gear housing, and is engaged with a helical wheel or worm wheel, wherein said pinion or said worm (1) is mounted radially and axially, wherein said gear (G) contains a bearing provided with balls (2) for the axial mounting of said pinion or said worm (1), which is secured in the axial direction (x) using at least one elastic element (5). The use of a special pivot bearing or pendulum bearing for a pivotable mounting of the pinion and/or the worm can even be disposed with by a helical bevel gear or worm gear (G) designed in this way. The axial mounting of the pinion or the worm can be implemented relatively simply and cost effectively, for example by a spring (5), the spring force thereof preferably being able to be adjusted using a set screw (6). Overall, a design of a low noise pinion or worm gear which is cost effective to produce and simple to handle in assembly thus results.

The invention is concerned with a spiral toothed wheel gear according to the preamble of claim 1 as well as an electrical auxiliary power steering according to the preamble of the additional independent claim furnished with the spiral toothed wheel gear.

A helical bevel gear of the kind in the form of a worm gear is known from the German printed patent document DE 101 61 715 A1 for the use in electrical auxiliary power steering. The gear described there is disposed in a housing and exhibits a worm as well as a worm wheel, wherein the worm is connected to the drive shaft of an electrical drive motor supported in a bearing by way of a coupling. The worm is supported swivelable perpendicular to the rotation axis and in a drag bearing or, respectively, a tumble bearing in the construction shown there, whereby the tooth forming play can be held constant during the complete lifetime of the gear. The worm is radially subjected with a pretension force for this purpose and is permanently pressed against the toothing of the worm wheel or, respectively, of the helical gear wheel. However, it has been shown in the context of such a known construction that the drag bearing or, respectively, the tumble bearing can be a cause for a strong noise emission. Furthermore, changes in direction of rotation or, respectively, changes in load in the gear together with a present tooth profile play can lead to the situation that the tooth flanks of the screw pinion or, respectively, of the worm bounce against the tooth flanks of the helical gear wheel or, respectively, of the worm wheel and cause beating noises. Nevertheless, no tooth flank play to low should be adjusted during assembly, since this can have a negative influence on the degree of effectiveness as well as on the wear of the gear. In addition, for example the restoring and feedback properties of an auxiliary force steering can be worsened, which in turn worsens the steering feeling at the driver.

Therefore, it is an object of the present invention, to overcome the above recited disadvantages by a simple and cost favorable solution to be realized. In particular, a spiral toothed wheel gear is to be proposed which exhibits clearly reduced bouncing noises during change of direction of rotation based on tooth flank play. Also an auxiliary force steering furnished with a spiral toothed wheel gear is to be proposed.

This object is obtained by a spiral toothed wheel gear with the features of claim 1 as well as through an auxiliary power steering with the features of the additional independent claim. The spiral toothed wheel gear can be formed as a worm gear.

Accordingly, a screw wheel or, respectively, a worm gear is proposed for an electrical auxiliary power steering which is characterized in that the spiral toothed wheel gear contains a bearing furnished with balls for the axial support of the screw pinion, wherein the bearing is secured in axial direction with at least one elastic element. The elastic element can preferably be formed as a spring.

The employment of a special drag bearing or, respectively, tumble bearing for a swivel support of the screw pinion or, respectively, worm can even be completely dispensed with through a such formed screw wheel gear or, respectively, worm gear. The axial support of the screw pinion or, respectively, the worm can relatively simple and cost favorable be realized through a spring, wherein the spring force can preferably be adjusted by way of a set screw. Overall there results a construction of a low noise screw wheel or, respectively, worm gear, wherein the construction is cost favorable in the production and simple to handle in assembly.

Advantageous further developments and embodiments of the invention result from the sub claims and from the embodiment examples described in the following by way of the accompanying schematic drawings, wherein:

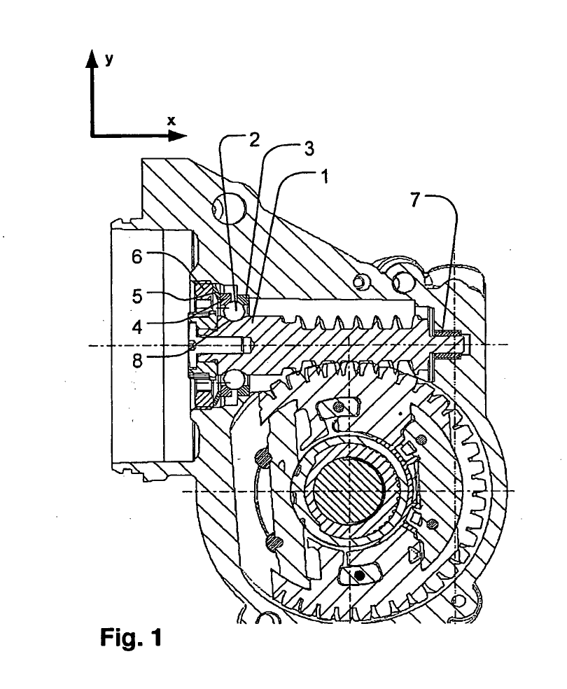

FIG. 1 shows a cross-sectional view of the first embodiment example of a worm gear according to the invention;

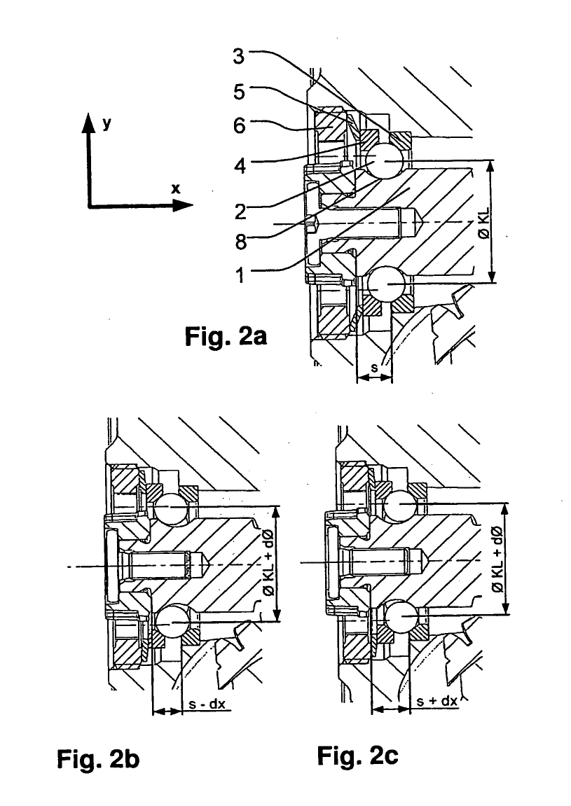

FIG. 2a-c shows in detail the support of the worm of the worm gear according to FIG. 1;

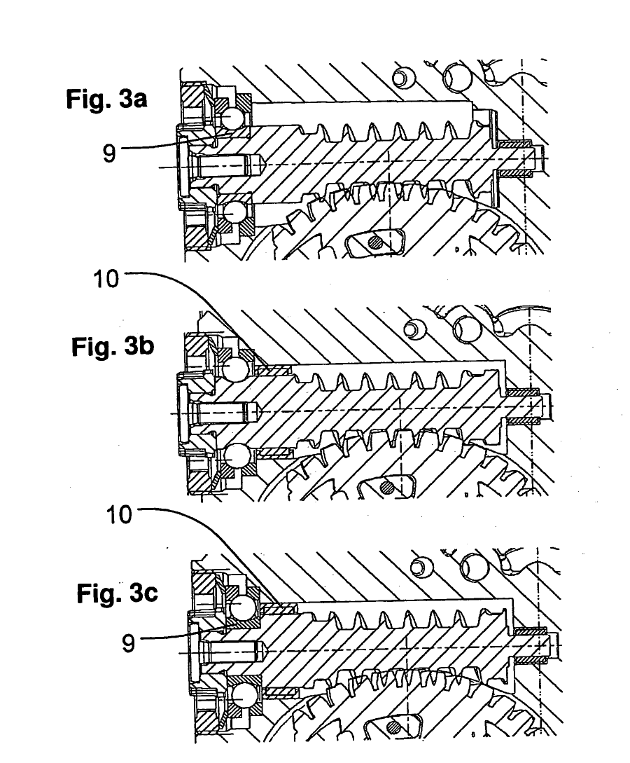

FIG. 3a-c shows the details of further embodiment examples for the support of the worm; and

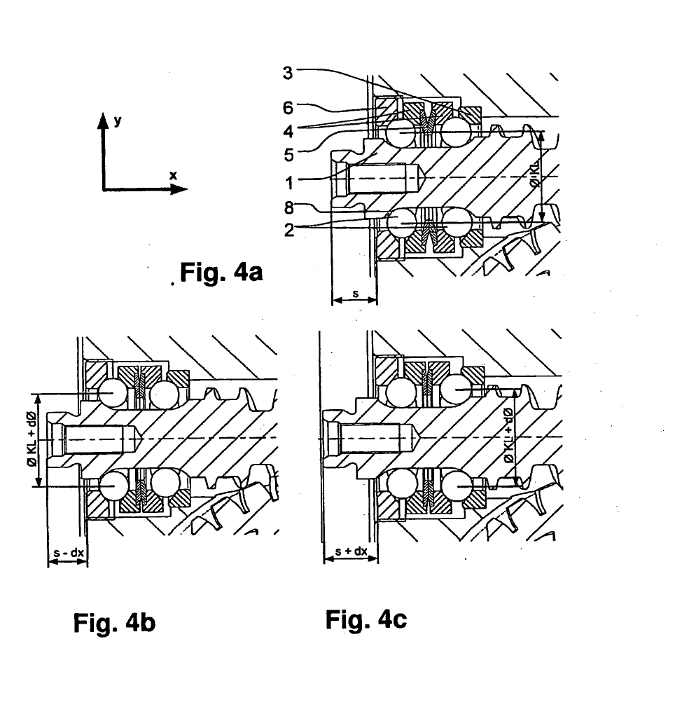

FIG. 4a-c shows in detail further embodiment examples for the support of the worm by way of two rows of balls.

The first embodiment form shown in the FIGS. 1 and 2a-c illustrates a worm gear G formed according to the present invention by way of example, wherein the worm 1 is elastically supported in axial direction x by way of a bearing furnished with balls 2. However, the invention is not limited specially to worm gears, but can generally be applied for each kind of screw wheel gears.

As can be recognized by way of these figures, the screw wheel gear or, respectively, worm gear G exhibits a worm 1 connectable with a drive shaft of an electrical drive motor, wherein the worm 1 is disposed in a gear housing and is in engagement with a worm wheel. An elastic support is furnished at the end of the worm connected to the drive shaft for reducing a tooth flank bounce noise induced in particular during load changes, wherein the elastic support subjects the worm 1 in axial direction x with a pretension force.

The axial support of the worm 1 is accomplished essentially by a bearing realized with balls 2, which bearing is secured in axial direction x by an elastic element, here by a spring 5. The spring 5 acts on a bearing ring 4 shiftable in axial direction, wherein the bearing ring 4 in turn is a part of the illustrated ball bearing and wherein the bearing ring 4 supports the ball in an axial direction as well as also in a radial direction. A non shiftable bearing ring 3 is disposed oppositely to the bearing ring 4, wherein the non shiftable bearing ring 3 is frame fixed connected to the housing of the gear G. The balls 2 are supported towards the outside by the two bearing rings 3 and 4. The balls run inwardly in a ball bearing slide 8, which slide can be directly formed at the worm for example.

The ball bearing slide can be formed both symmetrical as well as asymmetrical, wherein the characteristic lines “axial path the axial force of the worm” should be preferably identical for the two directions of motion. The course of the slope of the ball bearing slide 8 as well as the slope of the ball bearing slides of the two bearing rings 3 and 4 is preferably formed such that in the operation of the gear G the thereby generated radial forces at the bearing position can be securely transferred without that the worm 1 moves radially, that is in y direction. If that is a possible then the radial force has to be transferred by an additional movable bearing 10. The mold of effectiveness of this support is illustrated in particular by way of the FIGS. 2a-c.

The FIG. 2a shows the state wherein initially no axial force to be compensated acts on the worm 1. The balls 2 1 in the middle in the furnished ball bearing slide 8, wherein a first distance s between the housing fixed bearing ring 3 and the front face of the worm 1. Also a diameter KL determined by the balls becomes set. If now an axial force is exerted on the worm 1, then this effects a shifting of the balls 2 in the circulating slide 8 towards an edge region as it is shown in FIG. 2b or, respectively, FIG. 2c.

The FIG. 2b shows a situation, wherein a positive force acts in x-direction such that the balls 2 push against the left edge region of the ball circulating slide 8 and are lifted toward the left top corresponding to the shape of this ball bearing slide 8. The effective diameter KL of the ball bearing slide 8 is thereby enlarged and the distance s becomes reduced. This in turn leads to an upsetting deformation of the spring element 5, which thereby generates a restoring force, which operates against reflection or, respectively, shifting of the worm.

The corresponding situation is shown in FIG. 2c, wherein an oppositely directed force operates a shifting of the worm 1 towards the left. The shifting also leads to a lifting of the balls 2 within the ball bearing slide 8 and therewith also to a deflection of the elastic element or, respectively, the spring 5, which in turn generates an oppositely directed restoring force. Overall a restoring force is generated in each case through the elastic element or, respectively, the spring 5 operating in axial direction, wherein the restoring force opposes an occurring shifting of the worm 1.

Interfering noises are strongly reduced through such an elastic support of the worm 1. The tooth flanks of worm 1 and worm wheel bounce against each other based on the tooth flank play in case of a load direction change in a conventional gear and cause relatively high noise emissions. In such a case the worm 1 is shifted against the spring force of the spring 5 through the here proposed inventive construction and the bouncing energy (kinetic energy) is transformed in spring energy (potential energy), which leads to a clear decrease of the bouncing intensity and therewith leads to a reduction of the noises.

The axial shifting dx of the worm 1 depends on a characterizing line “axial path to axial force of the worm” as well as on the in each case occurring through engagement forces in the gear G. An axial shifting of the worm 1 is possible without occurrence of noises based on the special forming of the ball bearing slide 8. This is also possible through formation of a ball bearing inner ring 9 (compare FIGS. 3a and c).

If the worm 1 is shifted in axial direction, then the balls 2 change in their course diameter and the shiftable bearing ring 4 is shifted relative to the frame fixed bearing ring 3 in x-direction. The spring 5 disposed in contact with the bearing ring 4 is tensioned through this shifting of the bearing ring 4. The axial shifting of the worm 1 is terminated when a force balance occurs. If the tooth engagement forces decrease, then the worm 1 automatically moves back again into the starting position. The spring 5 can be optimally preset or, respectively, pretensioned already at the assembly of the gear G through a setting agent, which setting agent is for example formed as a setscrew 6 in order to thereby adjust to a desired characteristic line. The characteristic line is essentially defined by the spring characteristic line of the spring 5, by the forming of the ball bearing slide 8 and of the ball bearing slides of the bearing rings 3 and 4 in as well as by the elasticity of a possibly present ball bearing cage.

The balls 2 can but not necessarily have to be fixed by a ball bearing cage. If the balls 2 are fixed by a ball bearing cage, then the ball bearing cage can be formed elastically in circumferential direction. Alternatively, it can be provided that the ball bearing cage allows a change of the ball bearing slide diameter based on its form without blocking the balls 2. Metal or plastic can be preferably employed as material for the ball bearing cage.

Further embodiment examples are illustrated in the FIGS. 3a through 3c, wherein the FIGS. 3a and 3c in each case represent an embodiment where the balls are running in a ball bearing inner ring 9. The FIGS. 3b and 3c show in each case embodiment forms, wherein the worm exhibits additionally another radial bearing, which bearing is preferably realized by a movable bearing 10, which movable bearing 10 is disposed directly next to the described elastic axial bearing. The radial movable bearing 10 makes in particular sense, when based on the course of the slope of the ball bearing slides as well as the course of the characteristic line of the elastic element 5, it cannot be completely accomplished that radial forces generated during operation at the bearing position are completely and securely transferred. The additional movable bearing 10 makes sure in such cases that the worm 1 does not move in the radial direction.

Further embodiment forms are illustrated in FIGS. 4a-c, wherein the axial and also radial bearing of the worm is formed by two ball rows. Here the elastic element 5 is preferably disposed in each case between two ball circulations. The ball bearing slide 8 and is here formed so far that at least two ball circulations can be disposed in the ball bearing slide 8. A shifting of the worm 1 leads to that in each case only one of the two ball circulations is deflected and a restoring force set correspondingly opposite is generated in the elastic element 5. These embodiment forms have proven to be particularly low noise.

### LIST OF REFERENCE CHARACTERS

G spiral toothed wheel gear in the form of a worm gear

1 screw opinion in the form of a worm

2 ball of a ball bearing

3 first bearing ring, fixed to housing

4 second bearing ring, shiftable

5 elastic element in the form of a spring

6 setscrew

7 movable bearing

8 ball bearing slide

9 ball bearing inner ring

10 additional movable bearing

s distance

dx axial shift

KL diameter of ball bearing slide

dO change in diameter

1. Spiral toothed wheel gear (G) for an electrical auxiliary force steering, wherein the spiral toothed wheel gear (G) exhibits a screw pinion (1) connectable to a drive shaft of an electrical drive motor, wherein the screw pinion (1) is disposed in a gear housing and engages a screw wheel, wherein the screw pinion (1) is supported radially and axially, wherein the spiral toothed wheel gear (G) contains a bearing furnished with balls (2) for the axial support of the screw pinion (1), wherein the bearing is secured with at least one elastic element (5) in an axial direction (x) and that the spiral toothed wheel gear (G) exhibits at least one inner and one outer ball bearing slide, characterized in that at least one of the ball bearing slides is subdivided by the disposition of axially oppositely disposed bearing rings (3 and 4).

2. Spiral toothed wheel gear (G) according to claim 1, wherein the spiral toothed wheel gear is formed as a worm gear (G), wherein the screw wheel is formed as a worm wheel and the screw pinion is formed as a worm (1), wherein the worm (1) is engaged with the worm wheel.

3. Spiral toothed wheel gear (G) according to claim 1, wherein the elastic element is formed as a spring (5).

4. Spiral toothed wheel gear (G) according to claim 1, wherein the bearing furnished with balls (2) exhibits a bearing ring (4) with ball bearing slide and shiftable in axial direction (x), and wherein the elastic element (5) acts on the bearing ring (4).

5. Spiral toothed wheel gear (G) according to claim 1, wherein the bearing furnished with balls (2) exhibits a bearing ring (3) not shiftable in an axial direction (x) and with ball bearing slide.

6. Spiral toothed wheel gear (G) according to claim 1, wherein an axial restoring force generated by the elastic element (5) is changeable through set agents, in particular through an adjustment screw (6).

7. Spiral toothed wheel gear (G) according to claim 1, wherein the spiral toothed wheel gear (G) exhibits at least one ball bearing slide (8) for the balls (2), wherein the ball bearing slide (8) is formed on the screw pinion or, respectively, on the worm (1).

8. Spiral toothed wheel gear (G) according to claim 7, wherein at least one ball bearing slide (8) is formed as a course track slide of a ball bearing inner ring (9).

9. Spiral toothed wheel gear (G) according to claim 7, wherein the at least one ball bearing slide (8) formed as a course track for at least two rows of balls.

10. Spiral toothed wheel gear (G) according to claim 9, wherein the elastic element (5) is disposed between the ball circulations of the multiple rows ball bearing.

11. Spiral toothed wheel gear (G) according to claim 1, wherein the spiral toothed wheel gear (G) exhibits at least one additional bearing for a radial support of the worm (1), in particular at least one movable bearing (7, 10), in addition to the bearing furnished with balls (2) for the axial support of the worm (1).

12. Spiral toothed wheel gear (G) according to claim 1, wherein at least one of the bearings (10) for the radial support of the worm (1) is disposed directly next to the bearing for the axial support of the worm (1).

13. Spiral toothed wheel gear (G) according to claim 1, wherein the balls (2) are guided in at least one ball bearing cage, wherein the ball bearing cage is made in particular out of metal or plastic.

14. Spiral toothed wheel gear (G) according to claim 13, wherein at least one ball bearing cage is formed elastically in circumferential direction.

15. Spiral toothed wheel gear (G) according to claim 13, wherein at least one ball bearing cage is formed such that it allows a change of a ball bearing slide diameter of the balls (2).

16. The electrical auxiliary power steering for motor vehicle with a screw wheel gear, in particular worm wheel gear (G.), which exhibits a screw pinion connectable to a drive shaft for an electrical drive motor, in particular a worm (1), wherein the worm (1) is disposed in the gear housing and engaged with the screw wheel, in particular a worm wheel, wherein the screw pinion or, respectively, the worm (1) is radially and axially supported, wherein the spiral toothed wheel gear (G) contains a bearing furnished with balls (2), wherein the bearing is secured by at least one elastic element (5) and wherein the spiral toothed wheel gear (G) exhibits at least an inner ball bearing slide and an outer ball bearing slide, wherein at least one of the ball bearing slides is subdivided by the arrangement of axially oppositely disposed bearing rings (3 and 4).
